(19) United States
(12) Patent Application Publication
(10) Pub. No.: US 2025/0385845 A1
(43) Pub. Date: Dec. 18, 2025

(54) AIRCRAFT IN-FLIGHT ENTERTAINMENT DEVICES INSTALLATION VERIFICATION BY MACHINE VISION-ASSISTED IDENTIFICATION

(71) Applicant: Panasonic Avionics Corporation, Irvine, CA (US)

(72) Inventors: Hing Kei HO, Mission Viejo, CA (US); Jeremy Gerard Wei-Rong CHAN, Diamond Bar, CA (US); Ashley ZENG, Irvine, CA (US); Emilio RUEDA-QUEVEDO, Corona, CA (US); Diana JIANG, Irvine, CA (US); Tony SHEPHERD, Leighton Buzzard (GB)

(21) Appl. No.: 18/744,390

(22) Filed: Jun. 14, 2024

(51) Int. Cl. H04L 41/22; B64D 11/00; G06V 30/10; H04L 61/5007

(52) U.S. Cl. CPC H04L 41/22; B64D 11/0015; G06V 30/10; H04L 61/5007

(57) ABSTRACT

Systems, devices, and methods for aircraft in-flight entertainment (IFE) devices installation verification are disclosed herein. In some implementations, a verification system includes a computing device that can operably connect to multiple IFE devices and a reader device. Each IFE device can report its own stored identity to the computing device, and the computing device can determine the position of each IFE device based on a network topology-based network address assigned to each IFE device. The reader device can obtain and communicate, to the computing device, actual identities and expected installation positions of the IFE devices. The verification system can then compare, for each position, the actual identity, which indicates which IFE device should be installed in that position, against the reported stored identity, which indicates which IFE device has been installed in that position. The verification system can display, on a graphical user interface, the comparison.

### TECHNICAL FIELD

This disclosure is directed generally to systems, methods, and apparatuses for verifying installation of in-flight entertainment devices in aircraft using machine vision-assisted identification.

### BACKGROUND

The assembly of commercial aircraft, and particularly the assembly of passenger seat modules, requires proper installation of various in-flight entertainment (IFE) devices, including monitors, handsets, ports for transferring audio/power/data, seat electronics boxes, and seat power modules, into the passenger seat modules. To ensure that the IFE devices are installed in the correct seats and have proper wired connections, it is important to run tests to verify the installation. However, conventional systems and methods for such verification include, for example, an operator manually comparing the part number and the serial number of the IFE devices that are provided and reported. For IFE devices with associated displays, such as monitors and handsets, an operator may need to visually confirm their position based on information shown on the display. For IFE devices without associated displays, such as display-less handsets, an operator may need to visually confirm their position based on blinking LEDs on the device. For audio jacks and USB ports, an operator may need plug test devices in to test for proper audio output and data transfer, respectively.

Such conventional verification methods are both time and labor intensive, and may introduce human error. In addition to operators manually confirming each device, relying on visual confirmation via displays or other graphical user interfaces requires additional time to download and initialize associated graphical software stacks. Therefore, there is a need for an installation verification system that is more efficient and reliable.

### BRIEF DESCRIPTION OF THE DRAWINGS

Features, aspects, and advantages of the presently disclosed technology may be better understood with regard to the following drawings.

FIG. 1 shows an example of in-flight entertainment (IFE) devices installed in an airplane based on some implementations of the disclosed technology.

FIG. 2 shows an example block diagram of a computing device based on some implementations of the disclosed technology.

FIG. 3 is a schematic diagram of a verification system for verifying installation of IFE devices based on some implementations of the disclosed technology.

FIG. 4 is a schematic flowchart illustrating a process for verifying installation of IFE devices based on some implementations of the disclosed technology.

FIG. 5 is a schematic diagram of the verification system of FIG. 3 communicating with IFE devices based on some implementations of the disclosed technology.

FIG. 6 is a schematic diagram of select components of an IFE device based on some implementations of the disclosed technology.

FIG. 7 is a schematic flowchart illustrating a process for text-based data extraction by a reader device of the verification system of FIG. 3 based on some implementations of the disclosed technology.

FIG. 8 is a schematic diagram of the reader device of the verification system of FIG. 3 reading actual identities from machine-readable codes of IFE devices based on some implementations of the disclosed technology.

FIGS. 9A and 9B are schematic diagrams of graphical user interfaces displaying outputs of the verification system of FIG. 3 based on some implementations of the disclosed technology.

FIG. 10 is a schematic diagram of the verification system of FIG. 3 verifying installation in an economy class front row seat module based on some implementations of the disclosed technology.

FIG. 11 is a schematic diagram of the verification system of FIG. 3 verifying installation in an economy class middle row seat module based on some implementations of the disclosed technology.

FIG. 12 is a schematic diagram of the verification system of FIG. 3 verifying installation in an economy class rear row seat module based on some implementations of the disclosed technology.

FIG. 13 is a schematic diagram of the verification system of FIG. 3 verifying installation in a business class seat module based on some implementations of the disclosed technology.

FIG. 14 is a schematic diagram of the verification system of FIG. 3 verifying installation in another business class seat module based on some implementations of the disclosed technology.

FIG. 15 is a flowchart illustrating a process for verifying installation of IFE devices based on some implementations of the disclosed technology.

A person skilled in the relevant art will understand that the features shown in the drawings are for purposes of illustrations, and variations, including different and/or additional features and arrangements thereof, are possible.

### DETAILED DESCRIPTION

Various implementations of the disclosed technology provide techniques for verifying installation of in-flight entertainment (IFE) devices in aircraft using machine vision-assisted identification. Proper installation of IFE devices, such as monitors handsets, and audio ports, is crucial to ensuring seamless functionality and reliability during air travel, and to enhancing the overall passenger experience. Incorrect installations may lead to malfunctions, disrupting entertainment services and potentially compromising the safety and satisfaction of passengers. As an example, if the audio ports are not installed or wired properly, one passenger may listen to the audio output of a movie selected by a different passenger. As another example, if a passenger calls for a crew member using a handset that has not been installed or wired properly, the crew member may try to help a different passenger who has not called for assistance. In conventional verification systems, each IFE device needs to be manually and individually verified, such as by confirming that the display monitors, handsets, audio ports, USB ports, etc. work for each passenger seat. Such conventional verification systems can require a significant amount of time and can be susceptible to frequent human error in light of the extent of the manual involvement in the verification process.

In some implementations of the present technology, an IFE device installation verification system includes a computing device that can operably connect to multiple IFE devices installed on an airplane and to a reader device. Each of the IFE devices can report its own stored identity (e.g., part number, serial number) to the computing device, and the computing device can determine the position and/or wiring of each IFE device based on the network topology-based network (IP) address associated with the particular IFE device. For example, when a monitor reports its stored identity, the computing device can determine which seat that particular monitor has been installed based on the network topology-based network (IP) address assigned to the monitor. The reader device can obtain actual identities of the IFE devices and where each IFE device should be installed from documents, display devices, and/or physical labels. For example, the reader device can be a machine vision device that uses template feature matching and optical character recognition processes to obtain the actual identities of the IFE devices in text format. The reader device can then communicate the actual identities to the computing device.

In some implementations, the verification system can then compare, for each position (e.g., for a particular passenger seat), the actual identity, which indicates which IFE device should be installed in that position, against the reported stored identity, which indicates which IFE device has been installed by an operator in that position. The verification system can display, on a graphical user interface, the comparison and indicate specific errors, if any. If the verification system determines that the actual and stored identities match for all positions, the operator can be determined to have passed the verification process. If the verification system determines that at least one mismatch between the actual and stored identities exists, the operator can be determined to have failed the verification process.

Various implementations will be discussed in detail with reference to the figures below. In the description, the technology is described with respect to aircraft such as commercial planes, but the implementations of the disclosed technology can be applicable to other vehicles such as jets, buses, trains, ships, and other types of passenger vehicles.

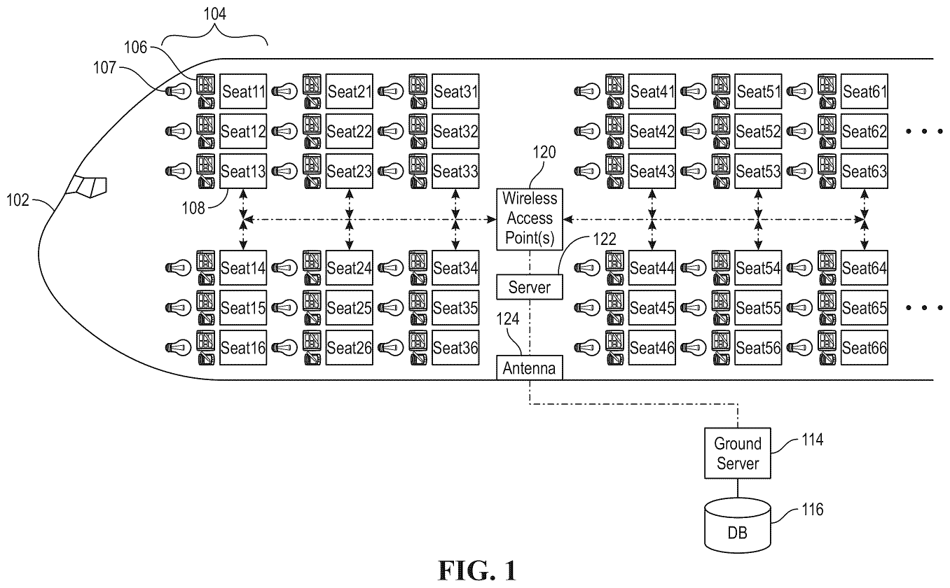

FIG. 1 shows in-flight entertainment (IFE) devices 106 installed in an airplane 102. In the illustrated embodiment, the airplane 102 includes seat modules 104, each with one or more passenger seats 108 (e.g., three seats 108 per seat module 104), one or more IFE devices 106 for each seat 108, and one or more power sources 107 (e.g., a power outlet, illustrated by the lightbulb icon in FIG. 1) for each seat 108. The IFE devices 106 can provide various entertainment and connectivity services, including video and audio streaming and Internet communications, to passengers on board. For example, the IFE devices 106 can include monitors, handsets, ports for transferring audio/power/data, etc. for each seat 108. The IFE devices 106 can also include a seat electronics box that connects to the IFE devices 106 corresponding to each seat module 104. The power sources 107 can provide power to, for example, personal electronic devices (PEDs) carried by passengers. The PEDs may refer to any electronic computing device that includes one or more processors or circuitries for implementing the functions related to data storage, video and audio streaming, wired communications, wireless communications, etc. The examples of the PEDs include cellular phones, smart phones, tablet computers, laptop computers, and other portable computing devices. In the implementations of the disclosed technology, the PEDs may have the capability to execute application software programs (“apps”) to perform various functions and/or communicate with the IFE devices 106.

In the illustrated embodiment, the passenger seats 108 are individually labeled Seat11 to Seat 66. In some implementations, the IFE devices 106 are provided at each passenger seat, such as located at each of the seatbacks of the passenger seats 108, and/or on cabin walls and/or deployable from an armrest for seats located at a bulkhead (i.e., in the first row of a section). The IFE devices 106 can include displays providing interfaces to each passenger through which each passenger enters their selections on the entertainment option, e.g., the particular selections, emergency requests, etc. Upon receiving the selection from the passengers, based on the selections from the passengers, the IFE devices 106 can display entertainment content and travel information. In the implementations of the disclosed technology, the IFE devices 106 can operate in a check-in mode which is separate from an entertain mode that receives the selections on the entertainment options from passengers and provides corresponding entertainment content. The IFE devices 106 can operate in the check-in mode until the passengers complete the onboard check-in process after getting on board and operate in the entertain mode after the passengers complete the onboard check-in. To encourage the passengers to complete the onboard check-in process, various graphic user interface (GUI) functions can be suggested and displayed on the IFE devices 106.

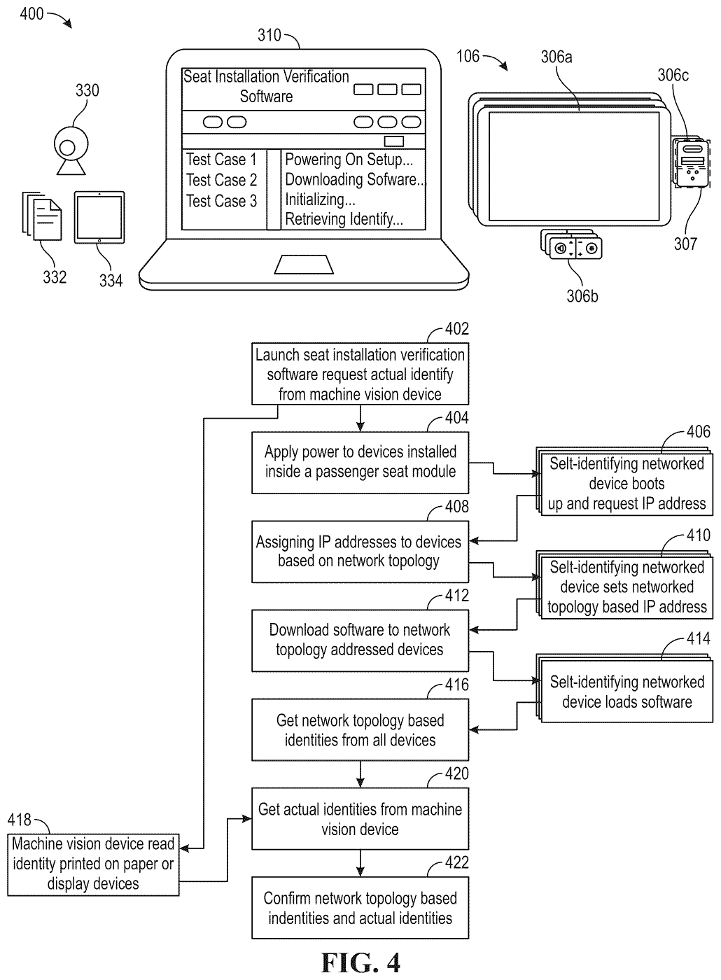

A server 122 can be communicably coupled with the IFE devices 106 and/or the PEDs via one or more wireless access points 120, and perform various operations including verifying proper installation of the IFE devices 106 as discussed with reference to FIG. 4. Additionally or alternatively, other servers not part of the airplane 102, such as a ground server 114 or a portable server, perform the installation verification process. The communications between the server 122 and the IFE devices 106 and the PEDs are either realized by wired connections or wireless connections. In some implementations, the communication among the server 122, the IFE devices 106, and the PEDs are achieved through the antenna 124 to and from ground-based cell towers by, for example, a provision of network plugs at the seat for the IFE devices 106 to a wired onboard local area network. In some other implementations, the communications among the server 122, the IFE devices 106, and the PEDs are achieved through another antenna to and from satellites in an orbit (not shown) (e.g., via a cellular network utilizing one or more onboard base station(s), Wi-Fi utilizing the wireless access point 120, and/or Bluetooth).

The server 122, the IFE devices 106, and the PEDs form a local network on board the airplane 102 through an onboard router (not shown). The server 122 is also communicably coupled with the ground server 114 through the antenna 124 for receiving and transmitting information from/to the ground server 114. The ground server 114 can be located at various locations, such as a computer center at an arbitrary location on the ground, etc. The ground server 114 may be in communication with a database 116, provide information from the database 116 to the server 122, and store information received from the server 122 in the database 116. Although FIG. 1 shows that the database 116 is provided separately from the ground server 114, the database 116 can be provided as a part of the ground server 114.

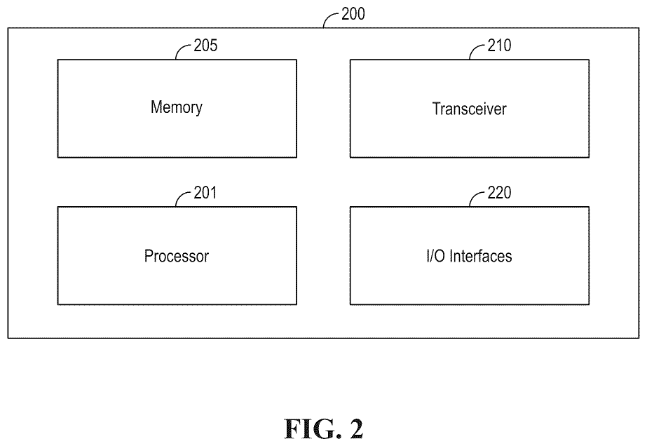

FIG. 2 shows an example block diagram of a computing device 200 (e.g., an onboard server, a ground server, or a portable server) based on some implementations of the disclosed technology. The computing device 200 includes at least one processor 201, a memory 205, a transceiver 210, and input/output (I/O) interface 220. In other embodiments, additional, fewer, and/or different elements may be used to configure the computing device 200. The memory 205 may store instructions and applications to be executed by the processor 201. The memory 205 is an electronic holding place or storage for information or instructions so that the information or instructions can be accessed by the processor 201. The memory 205 can include, but is not limited to, any type of random access memory (RAM), any type of read-only memory (ROM), any type of flash memory, such as magnetic storage devices (e.g., hard disk, floppy disk, magnetic strips, etc.), optical disks (e.g., compact disc (CD), digital versatile discs (DVD), etc.), smart cards, flash memory devices, etc. The instructions upon execution by the processor 201 configure the computing device 200 to perform the operations (e.g., the operations as shown in FIGS. 4-9B), which will be described in this patent document. The instructions executed by the processor 201 may be carried out by a special purpose computer, logic circuits, or hardware circuits. The processor 201 may be implemented in hardware, firmware, software, or any combination thereof. The term “execution” is, for example, the process of running an application or the carrying out of the operation called for by an instruction. The instructions may be written using one or more programming language, scripting language, assembly language, etc. By executing the instruction, the processor 201 can perform the operations called for by that instruction.

The processor 201 operably couples with the memory 205, the transceiver 210, and/or the I/O interfaces 220 to receive, send, and process information and to control the operations of the computing device 200. The processor 201 may retrieve a set of instructions from a permanent memory device, such as a ROM device, and copy the instructions in an executable form to a temporary memory device that is generally some form of RAM. In some implementations, the computing device 200 can include a plurality of processors that use the same or a different processing technology. The transceiver 210 may include a transmitter and a receiver. In some embodiments, the device 200 comprises a transmitter and a receiver that are separate from one another but functionally form a transceiver. The transceiver 210 transmits or sends information or data to another device (e.g., the IFE devices 106, a reader device, etc.) and receives information or data transmitted or sent by another device (e.g., another server, a PED, etc.).

A control module of the computing device 200 can be configured to perform operations to assist the computing device 200. In some implementations, the control module can be configured as a part of the processor 201. When the computing device 200 communicates with the IFE devices 106 in FIG. 1, the control module can be included in the airplane 102. In some implementations, the control module can operate machine learning/artificial intelligence (AI) applications that perform various types of data analysis to automate analytical model building. Using algorithms that iteratively learn from data, machine learning applications can enable computers to learn without being explicitly programmed. The machine learning/AI module may be configured to use data learning algorithms to build models to interpret various data received from the various devices or components to detect, classify, and/or predict future outcomes. Such data learning algorithms may be associated with rule learning, artificial neural networks, inductive logic programming, and/or clustering. In some implementations, the control module may assist the computing device 200 to perceive their environment and take actions that maximize the effectiveness of the operations performed by the computing device 200.

The I/O interfaces 220 enable data to be provided to the computing device 200 as input and enable the computing device 200 to provide data as output. In some embodiments, the I/O interfaces 220 may enable user input to be obtained and received by the computing device 200 (e.g., via a touch-screen display, buttons, or switches) and may enable the computing device 200 to display information. In some embodiments, devices, including touch screen displays, buttons, controllers, audio speakers, or others, are connected to the computing device 200 via I/O interfaces 220.

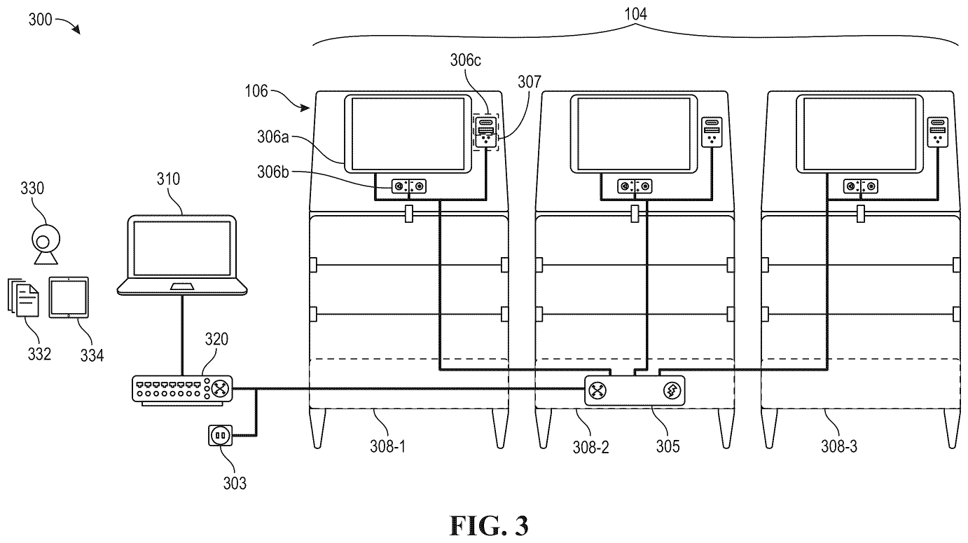

FIG. 3 is a schematic diagram of a verification system 300 for verifying installation of IFE devices 106 based on some implementations of the disclosed technology. As discussed above, each IFE device 106 can include software, hardware, or other components that require the IFE devices 106 to be installed in a position, such as in front of a particular passenger seat. However, manual installation of the IFE devices 106 can lead to installation in incorrect positions and/or installation with incorrect wiring. The verification system 300 can operate to verify whether each IFE device 106 is installed correctly with minimal human intervention, as discussed further with reference to FIG. 4.

The verification system 300 can include a computing device 310 (e.g., the computing device 200 schematically illustrated in FIG. 2) including at least one processor, a network switch 320, and a reader device 330. The computing device 310 can run a verification software, program, or set of instructions. The computing device 310 can be operably coupled to the network switch 320 and the reader device 330 via a wired or wireless connection. The seat module 104 can include a first passenger seat 308-1, a second passenger seat 308-2, a third passenger seat 308-3 (collectively referred to as “the passenger seats 308”), a plurality of IFE devices 106 for each of the passenger seats 308, and a seat electronics box 305 operably coupled to all or at least some of the IFE devices included in the seat module 104. The network switch 320 of the verification system 300 and the seat electronics box 305 can be operably coupled to one another, and coupled to an external power source 303.

In the illustrated embodiment, the IFE devices 106 for each passenger seat 308 includes a monitor 306a, a handset 306b, and one or more ports 306c (e.g., USB ports). The IFE devices 106 can also include the seat electronics box 305. Additional, fewer, or alterative IFE devices can be included in other embodiments. A power outlet 307 can also be provided for each passenger seat 308. The IFE devices 106 and the power outlet 307 of each passenger seat 308 can be operably coupled to the seat electronics box 305 via power and network cables.

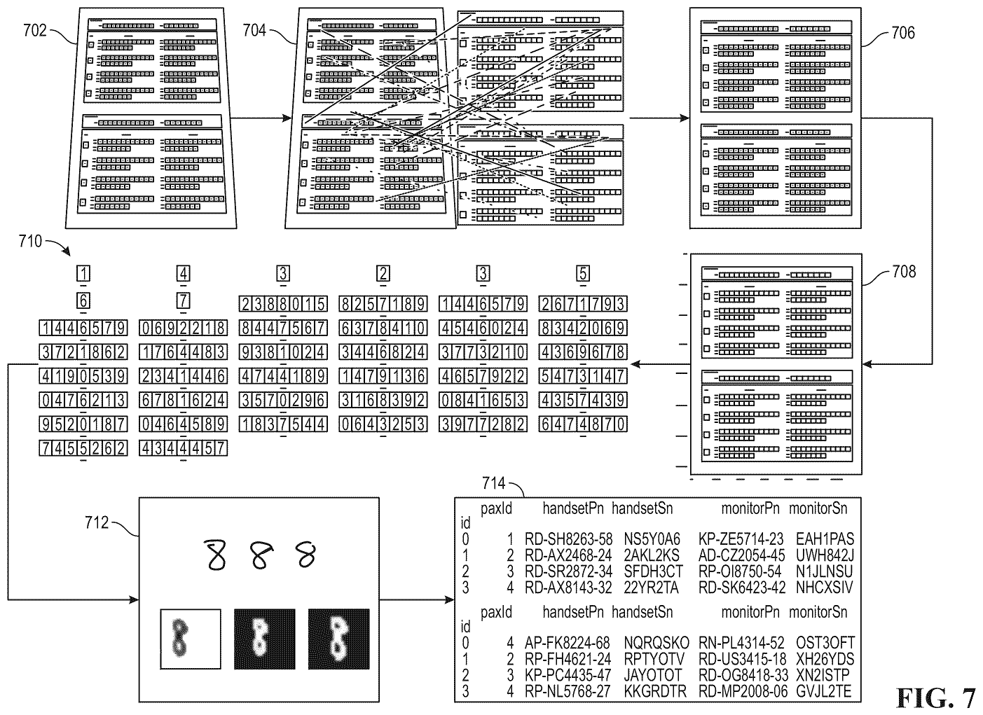

The reader device 330 can be an imaging device, a machine vision device, a scanner, or other device configured to read, scan, extract, or otherwise obtain data from printed or handwritten documents 332 and/or a display device 334. In some embodiments, the documents 332 and/or the display device 334 can include information regarding actual identities of the IFE devices 106 (e.g., in the form of part numbers and serial numbers) and where each IFE device 106 should be installed on the airplane 102. The documents 332 and/or the display device 334 can be prepared prior to operation of the verification system 300. Example operations of the reader device 330 are described in further detail with reference to FIG. 7.

FIG. 4 is a schematic flowchart 400 illustrating a process for verifying installation of the IFE devices 106 based on some implementations of the disclosed technology. At block 402, the computing device 310 launches the verification software, which requests the actual identities of the IFE devices 106 from the reader device 330. At block 404, once the IFE devices 106 are installed, the verification software enables the IFE devices 106 to power or boot up (e.g., receive power from the external power source 303 of FIG. 3).

At block 406, each IFE device 106 reads its own identity (e.g., stored identity), which can be stored in its memory (e.g., non-volatile memory). In some implementations, each IFE device 106 can be a self-identifying networked device that can read and communicate its own stored identity. The stored identity can include, for example, the part number and the serial number of the particular IFE device 106. Each IFE device 106 can also request a network (e.g., Internet Protocol (IP)) address from, for example, the verification software running on the computing device 310 or an IP address assigning service running on an upstream IFE device, such as the seat electronics box 305 (FIG. 3).

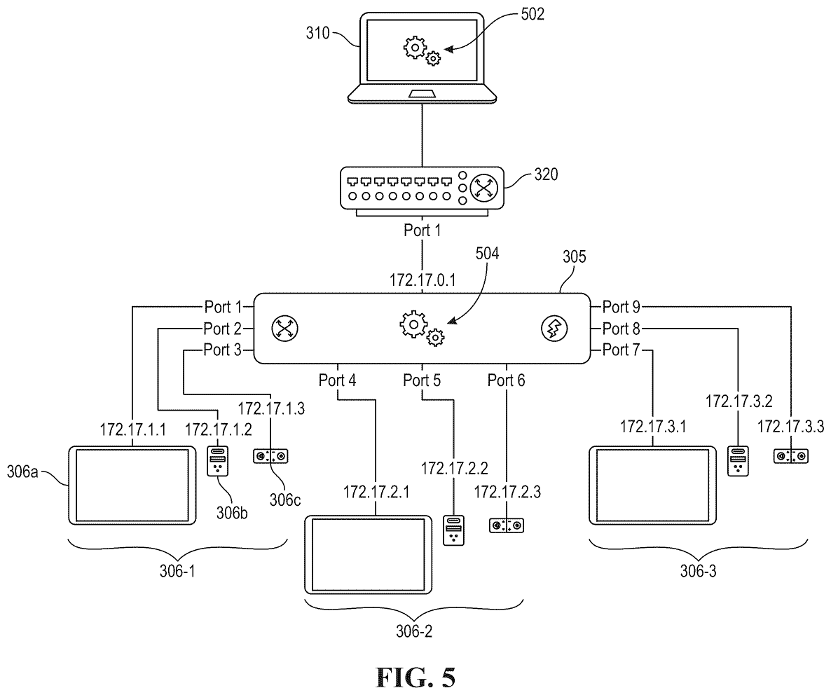

At block 408, the computing device 310 or the upstream IFE device can assign the requested IP addresses to the IFE devices 106. In some implementations, the IP addresses are assigned based on network topology, and thus each IP address is a network topology-based IP address. The IP address can include, for example, current wiring of the IFE device (e.g., what ports the IFE device 106 is connected to) and/or the current installation position of the IFE device (e.g., installed for Seat 43). At block 410, each IFE device 106 sets or otherwise stores the assigned IP address (e.g., network topology-based IP address). Assignment of the IP addresses to the IFE devices 106 is described in further detail with reference to FIGS. 4 and 5.

At block 412, the verification software running on the computing device 310 downloads a device software compatible with the verification software onto the IFE devices 106. At block 414, the IFE devices 106 can load the downloaded device software, which can enable or facilitate the IFE devices 106 to communicate further with the computing device 310. For example, the IFE devices 106 can communicate their stored identities and the assigned IP addresses to the computing device 310. At block 416, the computing device 310 receives the stored identities and the assigned IP addresses from the IFE devices 106.

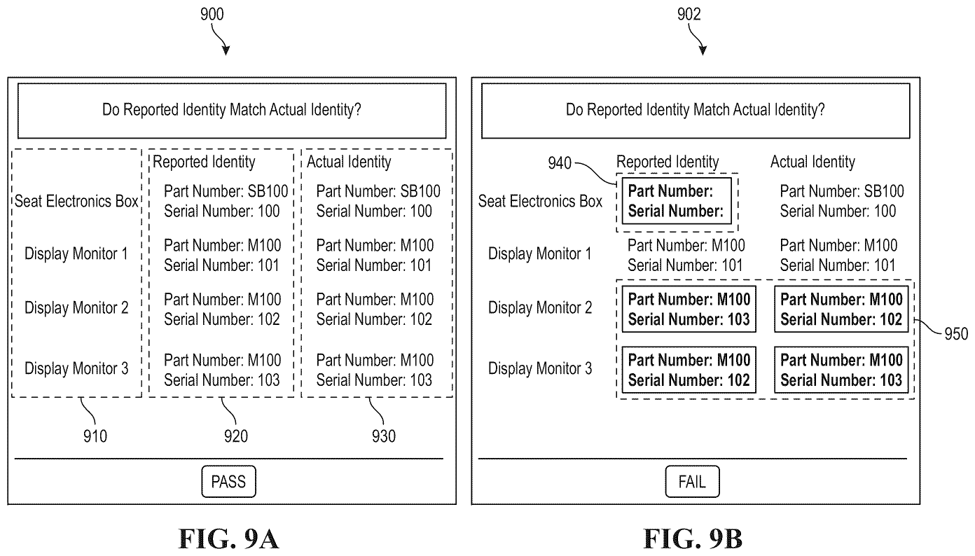

At block 418, in response to the request made by the computing device 310 at block 402, the reader device 330 reads or otherwise obtains the actual identities of the IFE devices 106 from the document 332 and/or the display device 334, and communicates the actual identities to the computing device 310. At block 420, the computing device 310 receives the actual identities of the IFE devices 106 from the reader device 330. At block 422, the computing device 310, or more specifically the verification software running on the computing device 310, compares the stored identities of the IFE devices 106 (received at block 416) against the actual identities of the IFE devices 106 (received at block 420), as described in further detail with reference to FIGS. 9A and 9B.

FIG. 5 is a schematic diagram of the verification system 300 communicating with IFE devices 306 based on some implementations of the disclosed technology. The computing device 310 can be configured to run a first IP address assigning service 502, and can be operably coupled to the seat electronics box 305 of a particular seat module via the network switch 320. The seat electronics box 305 can be configured to run a second IP address assigning service 504. In the illustrated embodiment, the seat electronics box 305 is connected to “Port1” of the network switch 320. Other seat electronic boxes of the airplane 102 can be connected to other ports of the network switch 320.

The seat electronics box 305 is further shown connected to the multiple IFE devices 306 of the corresponding seat module. For example, the seat module can include three passenger seats that correspond to three sets of IFE devices 306-1, 306-2, 306-3. Each set of IFE devices can include multiple IFE devices such as the monitor 306a, the handset 306b, and the ports 306c. Each IFE device 306 can be connected (e.g., by an operator) to the seat electronics box 305 via a port. For example, in the illustrated embodiment, the monitor 306a of the first set of IFE devices 306-1 is connected to “Port1” of the seat electronics box 305, the ports 306b are connected to “Port2” of the seat electronics box 305, and the handset 306c is connected to “Port 3” of the seat electronics box 305. The IFE devices of sets 306-2 and 306-3 are connected to “Port4” through “Port 9” of the seat electronics box 305.

In operation, when each of the IFE devices 306 boots up and requests an IP address (e.g., at block 406 of FIG. 4), the first IP address assigning service 502 can identify the port from which the request for the IP address originated. For example, when one of the illustrated IFE devices 306 requests an IP address, the first IP address assigning service 502 can determine that the request originated from “Port1” of the network switch 320, and assigns an IP address of “172.17.0.1” to the seat electronics box 305. The second IP address assigning service 504 can similarly determine from which port the request for the IP address originated from. For example, when the monitor 306a of the first set 306-1 requests an IP address, the second IP address assigning service 504 can determine that the request originated from “Port1” of the seat electronics box 305, and assigns an IP address of “172.17.1.1” to the monitor 306a (e.g., at block 408 of FIG. 4).

In some embodiments, the assigned IP addresses are network topology-based IP addresses, allowing the computing device 310 to determine an installation configuration (e.g., a specific position in the airplane 102, a position corresponding to a particular passenger seat 108) of the IFE device 306. As described further herein, each IFE device 306 can communicate its stored identity (e.g., at block 416 of FIG. 4) to the computing device 310, and the computing device 310 can then use both the stored identity and the network topology-based IP address to determine where any particular IFE device 306 has been installed. It is appreciated that the specific IP addresses illustrated in FIG. 5. (e.g., “172.17.1.1”) are only examples, and that other IP addresses and/or formats can be assigned.

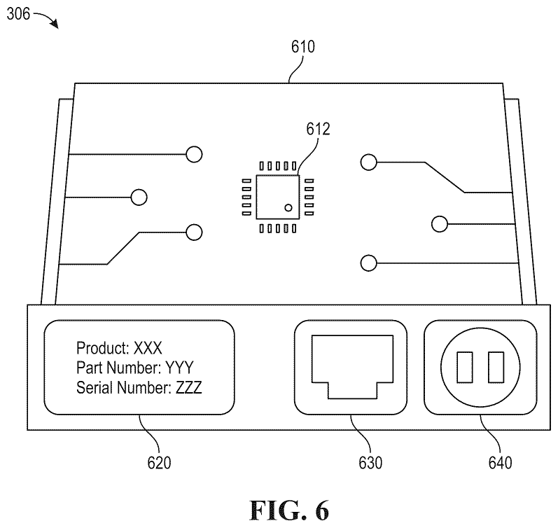

FIG. 6 is a schematic diagram of select components of an IFE device 306 based on some implementations of the disclosed technology. In some embodiments, the IFE device 306 includes a circuit board 610 (e.g., a printed circuit board), a memory 612 (e.g., a volatile memory, a non-volatile memory, an electrically erasable programmable read-only memory (EEPROM)) mounted on the circuit board 610, a physical label 620, a network connection port 630 (e.g., an ethernet cable port), and a power connection port or cable 640. The network connection port 630 and the power connection port or cable 640 can enable wired connectivity for the IFE device 306 to request for and be assigned a network topology-based IP address, as discussed with reference to FIG. 5.

The IFE device 306 can be assigned or provisioned a unique stored identity that can include a product code, a part number, a serial number, and/or other identifying features. The stored identity can be digitally stored in the memory 612 and printed on the physical label 620. The stored identity can be provisioned during, for example, the manufacturing process such that the stored identity stored inside the memory 612 matches the stored identity printed on the physical label 620.

In operation, the IFE device 306 can read or otherwise retrieve its unique stored identity from the memory 612 and communicate its stored identity to the computing device 310 (e.g., at block 416 of FIG. 4) via a wired connection through the network connection port 630 and/or wirelessly. The physical label 620 can serve as a backup measure to ensure that the correct stored identity is reported by the IFE device 306. As described further herein, the computing device 310 can then match the stored identity communicated from each IFE device with the network topology-based IP address assigned to the each IFE device to determine the installation location and/or wiring of the each IFE device.

FIG. 7 is a schematic flowchart illustrating a process for text-based data extraction by the reader device 330 (illustrated in FIG. 3) based on some implementations of the disclosed technology. The data extraction process and/or the image processing process can be performed by an algorithm or a machine learning model run on the reader device 330, the computing device 310, or a separate server (e.g., a cloud server). The process of FIG. 7 can correspond to blocks 418 and 420 of FIG. 4.

Process portion 702 illustrates a form listing the actual identities (in text format) of one or more IFE devices whose installation is to be verified by the verification system 300. For example, the form can list the product code, part number, serial number, etc. of each IFE device and the correct position and/or wiring with which the IFE device should be installed. The form can be in the form of the printed or handwritten documents 332 and/or be displayed on the display device 334. The reader device 330 can include a camera, scanner, or other imaging device that can read the form and its content. The reader device 330 can read the form prior to, during, or after the IFE devices are assigned the network topology-based IP addresses and/or communicate their stored identities to the computing device 310.

Process portion 704 illustrates the form illustrated in process portion 702 and a template. The template can be a standardized version of the form and can include one or more known features corresponding to to-be-identified features of the form. The algorithm can perform a feature matching process by comparing the form, which can be a photograph of the form at an angle, to the template. For example, the algorithm can identify features (e.g., a row listing the serial number of the first listed IFE device) and alter (e.g., cropping, resizing, rotating, stretching) the form such that the identified features of the form match the known features of the template. Process portion 706 illustrates an example altered version of the form, and process portion 708 illustrates the template with the expected absolute positions of the features. The feature matching process can use the expected absolute positions of the features in the template to determine where on the altered version of the form to find a certain type of data.

Process portion 710 illustrates isolated parts of the form corresponding to the features of interest. For example, the features of interest can include the product code, the part number, and/or the serial number of one or more IFE devices. As discussed above, the algorithm can determine what each feature of interest represents (e.g., whether a given string of numbers is a part number or a serial number) based on the expected absolute positions of the features in the template. Process portion 712 illustrates an image preprocessing process. For example, the top half of process portion 712 illustrates training data set characters (e.g., “8”) that can be used to train the algorithm or machine learning model. The bottom three squares illustrated in process portion 712 represent an unprocessed character, the character preprocessed by a contrast filter, and the character preprocessed by an edge filter, respectively. The preprocessing filters can render the character to be more similar to the training data set characters, allowing the algorithm or machine learning model to more reliably recognize the character in a subsequent optical character recognition (OCR) process. Process portion 714 illustrates example results of the OCR process in which the actual identities of the IFE devices have been identified by the algorithm or machine learning model.

In some implementations, the feature matching process can facilitate the text-based data extraction by the reader device 330 by enabling the algorithm to anticipate the type of data to be extracted. For example, in a conventional system using OCR, the algorithm may have difficulty distinguishing between the characters “B” and “8,” especially if the text has been handwritten. This can also be particularly problematic when, for example, the system cannot rely on a public network to access a powerful server due to security concerns and additional IT framework requirements. However, in some implementations of the disclosed technology, the verification system 300 anticipates the type of data based on the expected absolute positions of the features as determined from the template and known patterns of the associated feature. For example, if the verification system 300 determines, based on the feature matching process, that a particular string of characters represents a part number, and a part number is known to be a 7-digit string of characters that starts with three letters and ends with four numbers, a character in the 5^{th} digit place that would normally be difficult to ascertain whether it is a “B” or an “8” would be determined to be an “8” since the 5^{th} digit place is expected to include a number, not a letter.

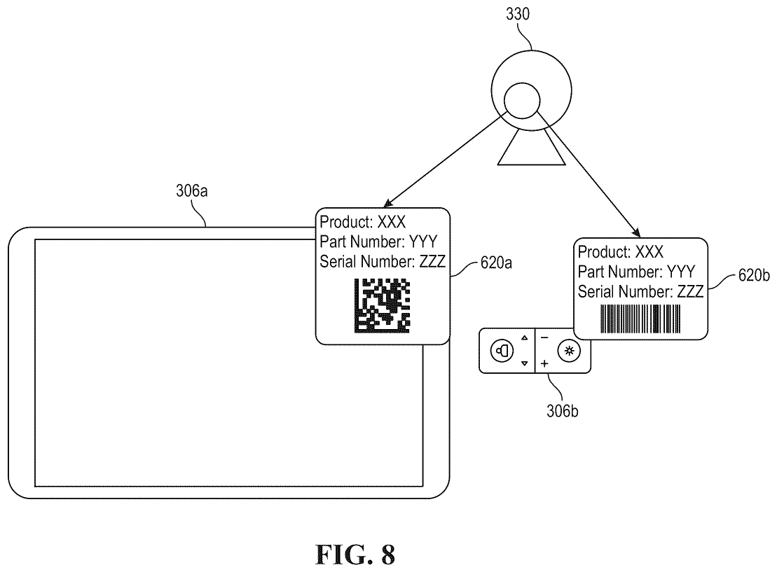

FIG. 8 is a schematic diagram of the reader device 330 reading actual identities from machine-readable codes of IFE devices 306 based on some implementations of the disclosed technology. As discussed above with reference to FIG. 7, the reader device 330 can extract or otherwise obtain the actual identities of IFE devices based on optically recognizing text. Additionally or alternatively, the reader device 330 can extract or otherwise obtain the actual identities of IFE devices based on scanning machine-readable codes. The schematic of FIG. 8 can correspond to blocks 418 and 420 of FIG. 4.

As discussed above with reference to FIG. 6, each IFE device 306 can include a physical label 620a showing the identity of the IFE device. In the illustrated embodiment, the monitor 306a has a physical label 620a with a two-dimensional machine-readable code (e.g., a QR code) and the handset 306b has a physical label 620b with a one-dimensional machine-readable code (e.g., a bar code). In some embodiments, the reader device 330 can scan the machine-readable codes of each IFE device 306 to obtain the identities of each IFE device 306.

FIGS. 9A and 9B are schematic diagrams of a first graphical user interface (GUI) 900 and of a second GUI 902, respectively, displaying outputs of the verification system 300 based on some implementations of the disclosed technology. FIGS. 9A and 9B can correspond to block 422 of FIG. 4.

Referring first to FIG. 9A, the first GUI 900 is shown displaying a first column 910 listing the IFE devices to be verified, a second column 920 listing the reported identities (e.g., stored identities), and a third column 930 listing the actual identities. The first column 910 can list positions on the airplane 102 in which IFE devices can be installed. For example, “Seat Electronics Box” can correspond to where the seat electronics box 305 for a particular seat module 104 should be installed, and “Display Monitor 1,” “Display Monitor 2,” and “Display Monitor 3” can correspond to where monitors 306a should be installed for the three individual passenger seats 108 in the particular seat module 104. The second column 920 can list the reported identities by part number and serial number, as shown. As discussed above with reference to FIGS. 5 and 6, the reported identities can be based on network topology-based IP addresses, allowing the verification system 300 to list the reported identities in the second column 920 in the same row as the corresponding position listed in the first column 910 of the first GUI 900. Therefore, the second column 920 represents how each IFE device has been installed and wired on the airplane 102, which may be correct or incorrect.

The third column 930 can list the actual identities by part number and serial number, as shown. As discussed above with reference to FIGS. 7 and 8, the actual identities can be extracted or otherwise obtained by the reader device 330 from the documents 332, the display device 334, or the machine-readable codes on physical labels 620a. In particular, the documents 332 and/or the display device 334 can also list where each IFE device should be installed, allowing the verification system 300 to list the actual identities in the third column 930 in the same row as the corresponding position listed in the first column 910 of the first GUI 900. Therefore, the third column 930 represents how each IFE device should be installed and wired on the airplane 102. The verification system 300 has determined that the report identities listed in the second column 920 match the actual identities listed in the third column 930, indicating that the IFE devices have been installed in the correct positions and with the correct wiring. Therefore, the first GUI 900 indicates that the operator has passed the verification process of the verification system 300.

Referring next to FIG. 9B, the second GUI 902 is shown displaying the positions, the reported identities, and the actual identities of the IFE devices, similar to the first GUI 900. However, unlike the first GUI 900, the second GUI 900 indicates multiple errors in the installation of the IFE devices. For example, block 940 shows that there is no part number or serial number received corresponding to the reported identity for the position corresponding to a seat electronics box. This may indicate, for example, that the seat electronics box has not been installed, that a wire has not been properly plugged into the seat electronics box, that the wire is broken or otherwise faulty, etc. In another example, block 950 shows that the serial number of the reported identity for “Display Monitor 2” matches the serial number of the actual identity for “Display Monitor 3.” Conversely, the serial number of the reported identity for “Display Monitor 3” matches the serial number of the actual identity for “Display Monitor 2.” This likely indicates that the installation of the monitors have been flipped (e.g., cross-wiring cables). Because the verification system 300 has determined at least one error, the second GUI 902 indicates that the operator has failed the installation verification process.

The IFE devices can include a self-identifying remote jack module or other device configured to provide audio and/or USB connectivity to a passenger. In some implementations, such devices are not networked and are unable to report their own identities. To confirm proper installation, operators would have to manually confirm the audio and/or USB connectivity of each device. For example, an operator can control the associated seat electronics box to cause headphones connected to the audio remote jack module to play a sound indicating its position. In another example, an operator can connect a USB hard drive storing a file indicating a proper position (e.g., “seat16D.txt.”) to the USB remote jack module to communicate the proper position to the associated seat electronics box.

In some implementations, however, one or more of the IFE devices are physically integrated in a single integrated unit that is a self-identifying networked device. For example, the single integrated unit can integrate the audio and USB connectivity jacks/ports, as well as a processor. The processor of the single integrated unit can digitalize audio signals and communicate data through the USB ports. In some implementations, the audio signals and/or the USB-transferred data can be transmitted between the computing device and the seat electronics box over a network. Because the single integrated unit is itself a self-identifying networked device, verifying installation of the single integrated unit can be sufficient to verify installation of the audio and USB connectivity jacks/ports.

In some implementations of the present technology, the verification system 300 enables an IFE installation verification process that avoids the need for operators to manually verify the installation position and wiring of each IFE device. Instead, as discussed above with reference to FIGS. 2-9B, the verification system 300 can digitally obtain the stored (reported) identities and the actual identities of multiple IFE devices, and display the comparison on a GUI for an operator to quickly identify the source and/or type of errors, if any, in the installation. By enabling a faster installation verification process, the verification system 300 can lead to increased production and reduce manual involvement in the process.

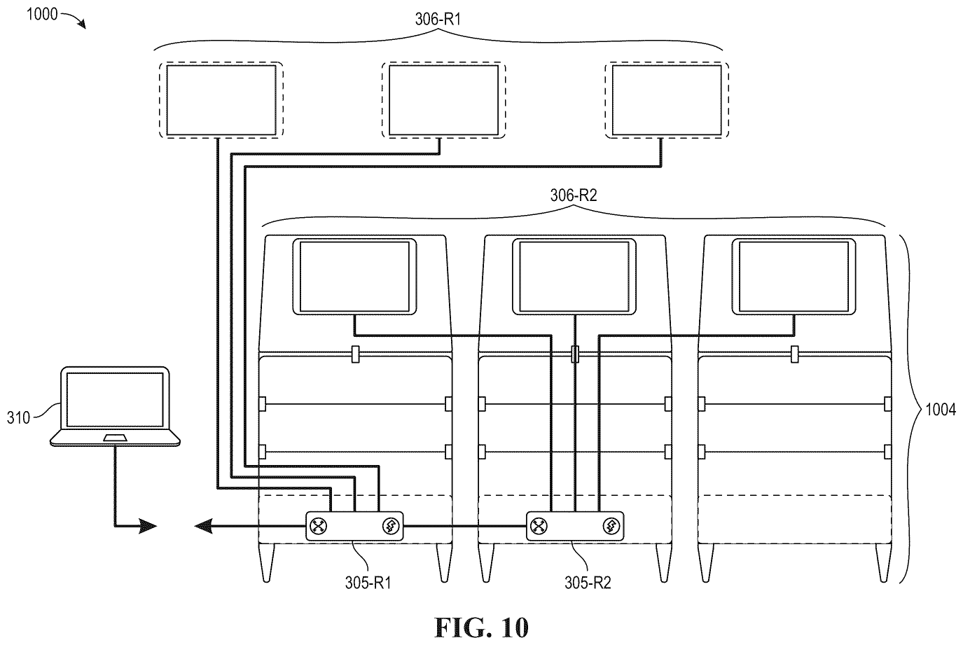

FIG. 10 is a schematic diagram 1000 of the verification system 300 verifying installation in an economy class front row seat module 1004 based on some implementations of the disclosed technology. In the illustrated embodiment, the computing device 310 is operably coupled to a first seat electronics box 305-R1 and a second seat electronics box 305-R2 (e.g., via a network switch not shown). The first seat electronics box 305-R1 is operably coupled to IFE devices 306-R1 of a front row (e.g., installed on a bulkhead of the airplane 102), which can serve passengers seated on the passenger seats of the front row seat module 1004. The second seat electronics box 305-R2 is operably coupled to IFE devices 306-R2 of a second row (installed on the backs of individual seats of the front row seat module 1004), which can serve passengers seated on passenger seats behind the front row seat module 1004. Because the first seat electronics box 305-R1 and the second seat electronics box 305-R2 may be installed in close proximity to one another, and because of forward-feeding cables to the IFE devices 306-R1 of the first row, it can be important to ensure that the wires extending from the IFE devices 306-R1 and 306-R2 are connected to the correct seat electronics box 305.

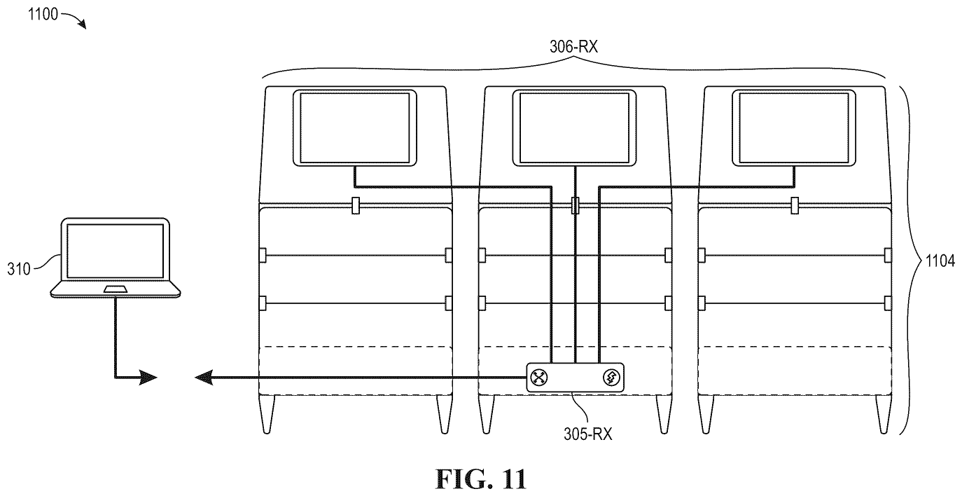

FIG. 11 is a schematic diagram 1100 of the verification system 300 verifying installation in an economy class middle row seat module 1104 based on some implementations of the disclosed technology. In the illustrated embodiment, the computing device 310 is operably coupled to a seat electronics box 305-RX (e.g., via a network switch not shown). The seat electronics box 305-RX is operably coupled to IFE devices 306-RX (installed on the backs of individual seats of the economy class middle row seat module 1104), which can serve passengers seated on passenger seats behind the illustrated middle row seat module 1104. Unlike the economy class front row seat module 1004, the economy class middle row seat module 1104 is associated with one seat electronics box and does not include forward-feeding cables.

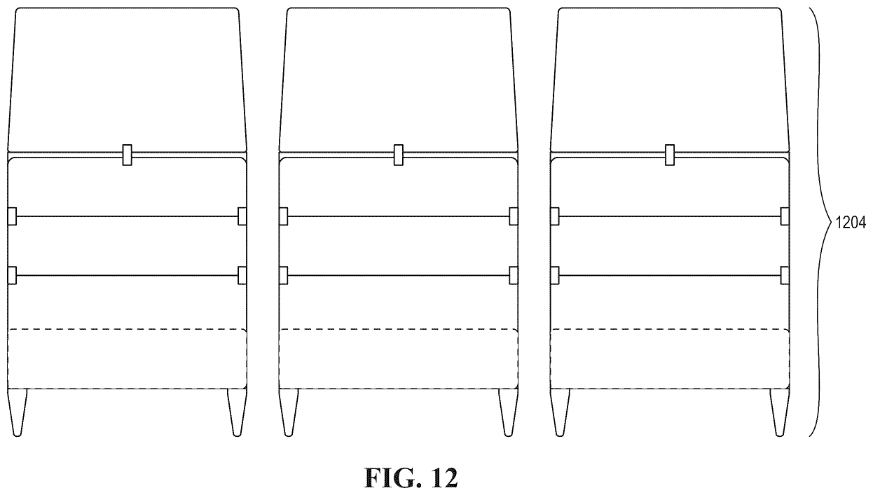

FIG. 12 is a schematic diagram 1200 of the verification system 300 verifying installation in an economy class rear row seat module 1204 based on some implementations of the disclosed technology. Because there are no passengers seated behind the rear row seat module 1204, there are no IFE devices installed and associated with the rear row seat module 1204.

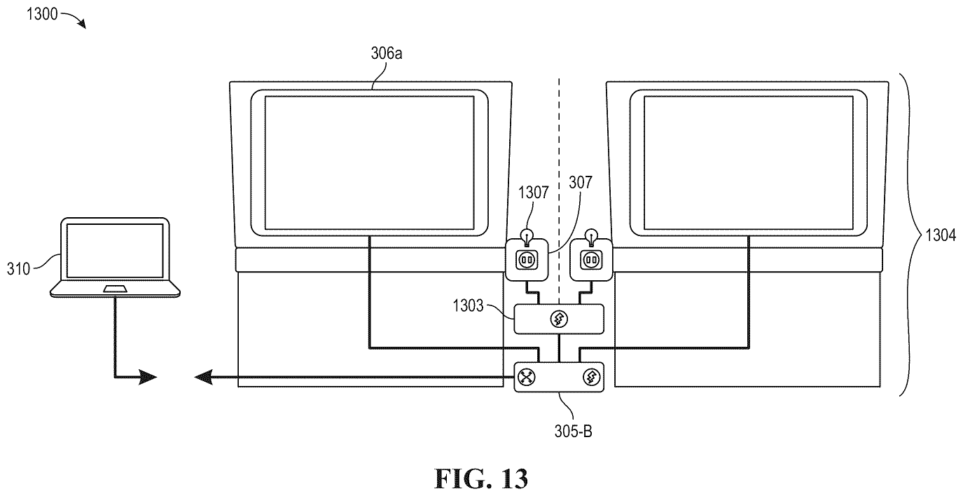

FIG. 13 is a schematic diagram 1300 of the verification system of 300 verifying installation in a business class seat module 1304 based on some implementations of the disclosed technology. In the illustrated embodiment, the computing device 310 is operably coupled to a seat electronics box 305-B. The seat electronics box 305-B is operably coupled to an in-seat power supply module 1303 (e.g., through serial communication), which is operably coupled to IFE devices, such as the monitor 306a, for two passenger seats. The in-seat power supply module 1303 is also coupled to provide power to the power outlets 307. As discussed above, the computing device 310 can verify installation of the monitor 306a (and other IFE devices not shown). However, in some embodiments, the power outlets 307 are not self-identifying networked devices, so the installation may not be verified via the identity comparison discussed above with reference to FIGS. 9A and 9B. Instead, an operator can turn on the power outlets 307 (e.g., one at a time or altogether, via a software) and use one or more testing devices 1307 (e.g., a testing lamp) to visually or otherwise manually confirm proper functioning of the power outlets 307.

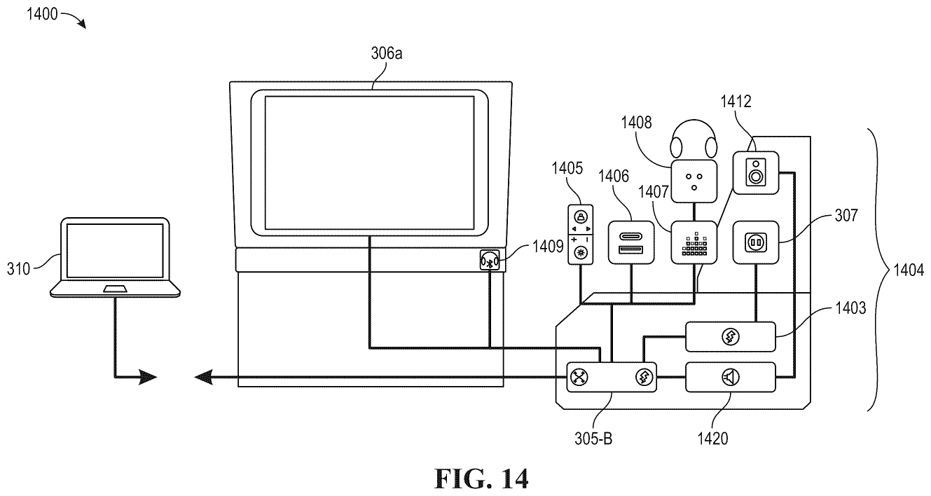

FIG. 14 is a schematic diagram 1400 of the verification system 300 verifying installation in another business class seat module 1404 based on some implementations of the disclosed technology. In the illustrated embodiment, the computing device 310 is operably coupled (e.g., wirelessly over a network) to the seat electronics box 305-B, which is operably coupled to IFE devices including the monitor 306a, a remote Bluetooth module 1409, a handset 1405, a USB charging remote jack module 1406, a smart audio adapter 1407, and an audio remote jack module 1408. The seat electronics box 305-B is also shown operably coupled to an in-seat power supply module 1403 (e.g., through serial communication), which is operably coupled to provide power to the power outlet 307, and a premium expansion unit 1420, which is operably coupled to a built-in speaker 1412.

In some implementations, the seat electronics box 305-B can be used to control the handset 1405 and/or the USB charging remote jack module 1406 over a network. The smart audio adapter 1407 can be configured to digitalize audio signals transferred to the audio remote jack module 1408. The seat electronics box 305-B can then transmit the digitalized audio signals to and/or from the computing device 310. The premium expansion unit 1420 can be configured to digitalize audio and provide power to the built-in speaker 1412.

In some implementations, the monitor 306a, the remote Bluetooth module 1409, the handset 1405, the USB charging remote jack module 1406, and the smart audio adapter 1407 are self-identifying networked devices that can read and communicate their own stored identities. However, the power outlet 307, the audio remote jack module 1408, and the built-in speaker 1412 may not be self-identifying networked devices, so their installation may not be verified via the identity comparison discussed above with reference to FIGS. 9A and 9B. Instead, to verify installation of the AC power outlet 307, an operator can turn on the power outlets 307 (e.g., one at a time or altogether, via a software) and use one or more testing devices (e.g., the testing lamp 1307) to visually or otherwise manually confirm proper functioning of the power outlets 307. To verify installation of the audio remote jack module 1408, the seat electronics box 305-B can be configured to cause a device (e.g., wired headphones) connected to the audio remote jack module 1408 to play a sound associated with its position (e.g., “This is Seat 3B′s wired headset”) such that the operator can confirm the position. To verify installation of the built-in speaker 1412, the premium expansion unit 1420 can be configured to cause the built-in speaker 1412 to play a similar sound (e.g., “This is Seat 3B's built-in speaker”) such that the operator can confirm the position.

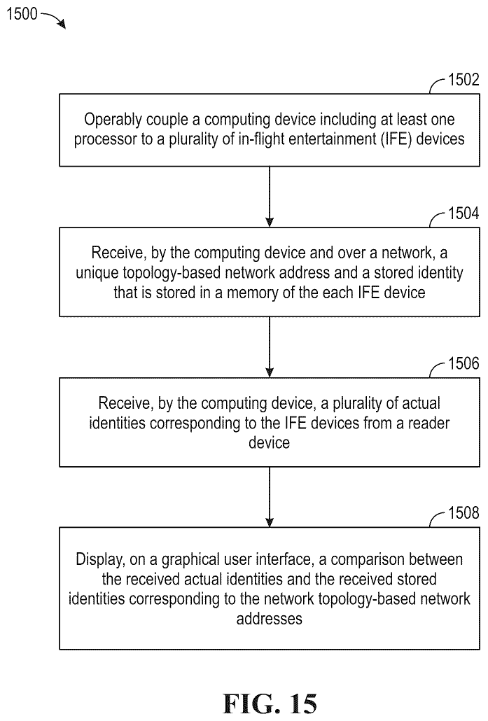

FIG. 15 is a flowchart illustrating a process or method 1500 for verifying installation of IFE devices based on some implementations of the disclosed technology. The method 1500 can include, at block 1502, operably coupling a computing device (e.g., the computing device 310) including at least one processor to a plurality of in-flight entertainment (IFE) devices (e.g., the IFE devices 306). In some embodiments, the computing device is coupled to the IFE devices via a network switch (e.g., the network switch 320) and/or an upstream IFE device (e.g., the seat electronics box 305).

The method 1500 can include, at block 1504, receiving, by the computing device and over a network, a unique topology-based network address assigned to the each IFE device and a stored identity that is stored in a memory of the each IFE device. As discussed above with reference to FIGS. 5 and 6, the topology-based network address (e.g., IP address) can be assigned to each IFE device by an address assigning service running on the computing device 310, the seat electronics box 305, and/or other devices. The stored identity can be stored in a memory (e.g., the memory 612) of each IFE device and can be communicated to the computing device through a wired or wireless connection.

The method 1500 can include, at block 1506, receiving, by the computing device, a plurality of actual identities corresponding to the plurality of IFE devices from a reader device (e.g., the reader device 330). As discussed above with reference to FIGS. 7 and 8, in some embodiments, a machine learning model or other algorithm can perform preprocessing and/or optical character recognition to obtain the actual identities in text form from documents 332 and/or display devices 334, and/or from a machine-readable code (e.g., a QR code or a bar code on the physical label 620a).

The method 1500 can include, at block 1508, displaying, on a graphical user interface (GUI) (e.g., the first or second GUIs 900, 902), a comparison between the received actual identities and the received stored identities corresponding to the unique topology-based network addresses of the IFE devices. As discussed above with reference to FIGS. 9A and 9B, the GUI can also indicate mismatches between the actual identities and the received stored identities, and the verification system 300 and/or the operator observing the GUI can determine the nature of the error (e.g., broken cable, flipped installation of two or more devices).

In some implementations, if a device's position cannot be determined over a network (e.g., via network topology-based network (IP) addresses), the verification system 300 can instruct IFE devices with displays to display its own identity. The reader device 330 (or a different reader device) can then read the displayed identities off of the displays of the IFE devices, avoiding the need to rely entirely on the network.

In accordance with the disclosed technology herein, some embodiments may incorporate the following technical solutions:

1. A system for verifying installation of in-flight entertainment devices, the system comprising:
a computing device including at least one processor and operably coupled to a plurality of in-flight entertainment (IFE) devices, wherein each IFE device is configured to: receive a network topology-based IP address; and
   report the received network topology-based IP address and a stored identity to the computing device over a network, wherein the stored identity comprises a unique identifier for the IFE device stored in a memory of the IFE device; and
a machine vision device configured to obtain a plurality of actual identities corresponding to the plurality of IFE devices and communicate the obtained actual identities to the computing device,
wherein the computing device is configured to display, on a graphical user interface, a comparison between the obtained actual identities and the reported stored identities corresponding to the network topology-based IP addresses of the IFE devices.

2. The system of solution 1, further comprising a network switch operably coupled to the computing device and the IFE devices, wherein the network switch is operably coupled to the IFE devices via one or more seat boxes, and wherein each IFE device is configured to receive the unique network topology-based IP address from at least one of a first IP address assigning service running on the processor of the computing device or a second IP address assigning service running on the one or more seat boxes.

3. The system of solution 1, wherein each IFE device is configured to report the stored identity to the computing device by displaying, on a display of the IFE device, the stored identity, wherein the displayed stored identity is configured to be captured by at least one of the machine vision device or a second machine vision device operably coupled to the computing device.

4. The system of solution 1, wherein the IFE devices include a self-identifying remote jack module configured to provide audio and USB connectivity to a passenger, wherein the IFE devices are integrated in a single integrated unit, and wherein the single integrated unit is configured to report a stored integrated identity over the network.

5. The system of solution 1, wherein the machine vision device is configured to obtain the plurality of actual identities from a plurality of identifiers using a machine learning model trained on identifier training sets to generate a list of actual identities based on feature matching between the identifiers and a template document.

6. The system of solution 1, wherein the machine vision device is configured to obtain the plurality of actual identities from at least one of a printed document, a handwritten document, a machine-readable code, or a label associated with the IFE devices.

7. The system of solution 1, wherein, when the system verifies installation of IFE devices associated with a front row seat module:
the computing device is operably coupled to a first set of IFE devices embedded in cabin furnishings via a first seat box, and
the computing device is operably coupled to a second set of IFE devices embedded in the front row seat module via a second seat box.

8. The system of solution 1, wherein the computing device is further configured to, upon displaying the comparison on the graphical user interface, indicate one or more errors associated with the installation of the IFE devices and corresponding one or more sources of the one or more errors.

9. A method for verifying installation of in-flight entertainment devices, the method comprising:
operably coupling a computing device including at least one processor to a plurality of in-flight entertainment (IFE) devices;
receiving, by the computing device and over a network, a unique topology-based network address assigned to the each IFE device and a stored identity that is stored in a memory of the each IFE device;
receiving, by the computing device, a plurality of actual identities corresponding to the plurality of IFE devices from a reader device; and
displaying, on a graphical user interface, a comparison between the received actual identities and the received stored identities corresponding to the unique topology-based network addresses of the IFE devices.

10. The method of solution 9, wherein operably coupling the computing device to the IFE devices comprises operably coupling a network switch between the computing device and the IFE devices, wherein the network switch is operably coupled to the IFE devices via one or more seat boxes, and wherein the method further comprises:
configuring at least one of a first network address assigning service running on the at least one processor of the computing device or a second network address assigning service running on the one or more seat boxes to assign the unique topology-based network address to each IFE device.

11. The method of solution 9, wherein receiving the stored identity from each IFE device comprises capturing, using at least one of the reader device or a second reader device operably coupled to the computing device, the stored identity that is displayed on a display of each IFE device.

12. The method of solution 9, wherein the IFE devices include a self-identifying remote jack module configured to provide audio and USB connectivity to a passenger, wherein the IFE devices are integrated in a single integrated unit, and wherein the single integrated unit is configured to report a stored integrated identity over the network, and wherein receiving the stored identity from the IFE device comprises receiving, from the single integrated unit and over the network, the stored integrated identity.

13. The method of solution 9, wherein the reader device is configured to extract the plurality of actual identities from a plurality of identifiers using a machine learning model trained on identifier training sets to generate a list of actual identities based on feature matching between the identifiers and a template document.

14. The method of solution 9, wherein operably coupling the computing device to the IFE devices comprises:
when verifying installation of IFE devices associated with a front row seat module—
   operably coupling the computing device to a first set of IFE devices embedded in cabin furnishings via a first seat box; and
   operably coupling the computing device to a second set of IFE devices embedded in the front row seat module via a second seat box.

15. A computer-readable medium including processor instructions that, when executed by one or more processors, cause the one or more processors to:
receive, over a network, a unique topology-based network address and a stored identity from each of a plurality of in-flight entertainment (IFE) devices;
receive a plurality of actual identities corresponding to the IFE devices from a reader device; and
display, on a graphical user interface, a comparison between the received actual identities and the received stored identities corresponding to the network topology-based network addresses of the IFE devices.

16. The computer-readable medium of solution 15, wherein the processor instructions cause the one or more processors to instruct at least one of a first network address assigning service running on the one or more processors or a second network address assigning service running on one or more seat boxes to assign the unique topology-based network address to each IFE device, wherein the one or more seat boxes are operably coupled to the IFE devices.

17. The computer-readable medium of solution 15, wherein the one or more processors receive the stored identity from each IFE device by capturing, using at least one of the reader device or a second reader device operably coupled to the one or more processors, the stored identity that is displayed on a display of each IFE device.

18. The computer-readable medium of solution 15, wherein the IFE devices include a self-identifying remote jack module configured to provide audio and USB connectivity to a passenger, wherein the IFE devices are integrated in a single integrated unit, and wherein the one or more processors receive the stored identity from the IFE device by receiving, from the single integrated unit and over the network, a stored integrated identity.

19. The computer-readable medium of solution 15, wherein the reader device is configured to extract the plurality of actual identities from a plurality of identifiers using a machine learning model trained on identifier training sets to generate a list of actual identities based on feature matching between the identifiers and a template document.

20 The computer-readable medium of solution 15, wherein the processor instructions cause the one or more processors to verify installation of IFE devices associated with a front row seat module by:
operably coupling to a first set of IFE devices embedded in cabin furnishings via a first seat box; and
operably coupling to a second set of IFE devices embedded in the front row seat module via a second seat box.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described, and other implementations, enhancements and variations can be made based on what is described and illustrated in this patent document.

1. A system for verifying installation of in-flight entertainment devices, the system comprising:
a computing device including at least one processor and operably coupled to a plurality of in-flight entertainment (IFE) devices, wherein each IFE device is configured to:
receive a network topology-based IP address; and
report the received network topology-based IP address and a stored identity to the computing device over a network, wherein the stored identity comprises a unique identifier for the IFE device stored in a memory of the IFE device; and
a machine vision device configured to obtain a plurality of actual identities corresponding to the plurality of IFE devices and communicate the obtained actual identities to the computing device,
wherein the computing device is configured to display, on a graphical user interface, a comparison between the obtained actual identities and the reported stored identities corresponding to the network topology-based IP addresses of the IFE devices.

2. The system of claim 1, further comprising a network switch operably coupled to the computing device and the IFE devices, wherein the network switch is operably coupled to the IFE devices via one or more seat boxes, and wherein each IFE device is configured to receive the unique network topology-based IP address from at least one of a first IP address assigning service running on the processor of the computing device or a second IP address assigning service running on the one or more seat boxes.

3. The system of claim 1, wherein each IFE device is configured to report the stored identity to the computing device by displaying, on a display of the IFE device, the stored identity, wherein the displayed stored identity is configured to be captured by at least one of the machine vision device or a second machine vision device operably coupled to the computing device.

4. The system of claim 1, wherein the IFE devices include a self-identifying remote jack module configured to provide audio and USB connectivity to a passenger, wherein the IFE devices are integrated in a single integrated unit, and wherein the single integrated unit is configured to report a stored integrated identity over the network.

5. The system of claim 1, wherein the machine vision device is configured to obtain the plurality of actual identities from a plurality of identifiers using a machine learning model trained on identifier training sets to generate a list of actual identities based on feature matching between the identifiers and a template document.

6. The system of claim 1, wherein the machine vision device is configured to obtain the plurality of actual identities from at least one of a printed document, a handwritten document, a machine-readable code, or a label associated with the IFE devices.

7. The system of claim 1, wherein, when the system verifies installation of IFE devices associated with a front row seat module:
the computing device is operably coupled to a first set of IFE devices embedded in cabin furnishings via a first seat box, and
the computing device is operably coupled to a second set of IFE devices embedded in the front row seat module via a second seat box.

8. The system of claim 1, wherein the computing device is further configured to, upon displaying the comparison on the graphical user interface, indicate one or more errors associated with the installation of the IFE devices and corresponding one or more sources of the one or more errors.

9. A method for verifying installation of in-flight entertainment devices, the method comprising:
operably coupling a computing device including at least one processor to a plurality of in-flight entertainment (IFE) devices;
receiving, by the computing device and over a network, a unique topology-based network address assigned to the each IFE device and a stored identity that is stored in a memory of the each IFE device;
receiving, by the computing device, a plurality of actual identities corresponding to the plurality of IFE devices from a reader device; and
displaying, on a graphical user interface, a comparison between the received actual identities and the received stored identities corresponding to the unique topology-based network addresses of the IFE devices.

10. The method of claim 9, wherein operably coupling the computing device to the IFE devices comprises operably coupling a network switch between the computing device and the IFE devices, wherein the network switch is operably coupled to the IFE devices via one or more seat boxes, and wherein the method further comprises:
configuring at least one of a first network address assigning service running on the at least one processor of the computing device or a second network address assigning service running on the one or more seat boxes to assign the unique topology-based network address to each IFE device.

11. The method of claim 9, wherein receiving the stored identity from each IFE device comprises capturing, using at least one of the reader device or a second reader device operably coupled to the computing device, the stored identity that is displayed on a display of each IFE device.

12. The method of claim 9, wherein the IFE devices include a self-identifying remote jack module configured to provide audio and USB connectivity to a passenger, wherein the IFE devices are integrated in a single integrated unit, and wherein the single integrated unit is configured to report a stored integrated identity over the network, and wherein receiving the stored identity from the IFE device comprises receiving, from the single integrated unit and over the network, the stored integrated identity.

13. The method of claim 9, wherein the reader device is configured to extract the plurality of actual identities from a plurality of identifiers using a machine learning model trained on identifier training sets to generate a list of actual identities based on feature matching between the identifiers and a template document.

14. The method of claim 9, wherein operably coupling the computing device to the IFE devices comprises:
when verifying installation of IFE devices associated with a front row seat module—
operably coupling the computing device to a first set of IFE devices embedded in cabin furnishings via a first seat box; and
operably coupling the computing device to a second set of IFE devices embedded in the front row seat module via a second seat box.

15. A computer-readable medium including processor instructions that, when executed by one or more processors, cause the one or more processors to:
receive, over a network, a unique topology-based network address and a stored identity from each of a plurality of in-flight entertainment (IFE) devices;
receive a plurality of actual identities corresponding to the IFE devices from a reader device; and
display, on a graphical user interface, a comparison between the received actual identities and the received stored identities corresponding to the network topology-based network addresses of the IFE devices.

16. The computer-readable medium of claim 15, wherein the processor instructions cause the one or more processors to instruct at least one of a first network address assigning service running on the one or more processors or a second network address assigning service running on one or more seat boxes to assign the unique topology-based network address to each IFE device, wherein the one or more seat boxes are operably coupled to the IFE devices.

17. The computer-readable medium of claim 15, wherein the one or more processors receive the stored identity from each IFE device by capturing, using at least one of the reader device or a second reader device operably coupled to the one or more processors, the stored identity that is displayed on a display of each IFE device.

18. The computer-readable medium of claim 15, wherein the IFE devices include a self-identifying remote jack module configured to provide audio and USB connectivity to a passenger, wherein the IFE devices are integrated in a single integrated unit, and wherein the one or more processors receive the stored identity from the IFE device by receiving, from the single integrated unit and over the network, a stored identity.

19. The computer-readable medium of claim 15, wherein the reader device is configured to extract the plurality of actual identities from a plurality of identifiers using a machine learning model trained on identifier training sets to generate a list of actual identities based on feature matching between the identifiers and a template document.

20. The computer-readable medium of claim 15, wherein the processor instructions cause the one or more processors to verify installation of IFE devices associated with a front row seat module by:
operably coupling to a first set of IFE devices embedded in cabin furnishings via a first seat box; and
operably coupling to a second set of IFE devices embedded in the front row seat module via a second seat box.
